(19) United States
(12) Patent Application Publication
(10) Pub. No.: US 2024/0109790 A1
(43) Pub. Date: Apr. 4, 2024

(54) Installation Assistance Features and Methods for Installation of a Water Filter

(71) Applicant: Think Tank Investments, LLC, Louisville, KY (US)

(72) Inventors: Andrew Reinhard Krause, Louisville, KY (US); Andrew Joseph Brinker, Louisville, KY (US); William Thomas Moon, Taylorsville, KY (US); Charles Michael Cassaro, Prospect, KY (US)

(21) Appl. No.: 18/274,602

(22) PCT Filed: Jan. 28, 2022
(86) PCT No.: PCT/US22/14183

§ 371 Date: Jul. 27, 2023

Related U.S. Application Data
(60) Provisional application No. 63/143,181, filed on Jan. 29, 2021.

(51) Int. Cl. C02F 1/00

(52) U.S. Cl. CPC C02F 1/001; C02F 2201/004; C02F 2209/006; C02F 2307/10; C02F 2307/12

(57) ABSTRACT

An appliance is provided including a fluid flow path and a filter receiving portion. The filter receiving portion comprises an installation assistance feature and is configured to receive a water filter such that it is fluidly connected to the flow path. One or more water filter sensors are included that sense when the water filter is in a first position relative to the filter receiving portion so as to enable initiation of an installation procedure to cause the water filter to move to the installed position. The installation procedure utilizes no the installation assistance feature. At least one controller is provided that receives an indication that the water filter is in a first position and causes, based on the indication, activation of the installation assistance feature to reposition the water filter from the first position towards the installed position.

### CROSS REFERENCE TO RELATED APPLICATIONS

This application claims priority to U.S. Provisional Application No. 63/143,181, filed on Jan. 29, 2021, wherein is incorporated by reference in its entirety herein.

### FIELD OF THE INVENTION

Embodiments of the present invention relate generally to water filters, and more particularly to the installation of water filters, such as in appliances.

### BACKGROUND OF THE INVENTION

Installation of components within an appliance is often difficult for users, and this is particularly true for the installation of water filters in appliances. Shifting a water filter to the correct position within an appliance is often a difficult task as a user may have great difficulty in reaching the correct installed position. Indeed, depending on the installation direction and position of the water filter within the appliance, it can be difficult for a user to properly position and maneuver the water filter during installation. For example, water filters are required to be connected to a flow path of water within the appliance, and this flow path is typically at a location in the back of the appliance. Additionally, sometimes contents of the appliance may be in the way, further complicating the process (e.g., food items may be in the way of installing a water filter in the back of a refrigerator).

Moreover, appliances may not provide any confirmation that a water filter is properly positioned or installed. In this regard, a related risk is that a user may unknowingly fail to secure a water filter in the correct installed position. Where a water filter is not properly installed, this may result in a potential safety hazard, diminished performance for the appliance, or damage to the appliance.

### BRIEF SUMMARY OF THE INVENTION

Improved water filters, appliances, filter receiving elements, and improved methods for installing water filters are therefore contemplated that address the issues described above.

Example embodiments of the present invention provide an improved filter receiving portion that may be implemented in an appliance. This filter receiving portion may comprise an installation assistance feature that allows for a water filter to be easily installed into and removed from an appliance. A user is simply required to place the water filter in a first position close to the filter receiving portion, and the installation assistance feature of the filter receiving portion may then move the water filter within the appliance to its installed position. In this way, the water filter may be fluidly connected to the appropriate fluid flow path within the appliance. The water filter may be shifted to its installed position without any rotation to ensure the proper installation of the water filter.

One or more water filter sensors are provided that assist with the installation of a water filter into an appliance. These water filter sensors may provide an indication of when the water filter is in a first position to alert the system that an installation procedure may be initiated. After the installation assistance feature moves the water filter towards its installed position, the water filter sensors may also provide an indication that the water filter is at the installed position. In some embodiments, magnetic material is provided within the filter receiving portion to assist with placement of the water filter into the first position and/or the installed position. By including the water filter sensors and/or magnetic material, the filter receiving portion and the installation assistance feature may assist in installing a water filter so that it is fluidly connected to a fluid flow path within an appliance.

In some embodiments, a timer or a count is also provided. This timer or count may track the time that a water filter has been installed within an appliance or the time until the water filter needs to be replaced. Upon successful installation of a water filter, this timer or count may be reset.

In an example embodiment, an appliance is provided. The appliance comprises a fluid flow path. The appliance also comprises a filter receiving portion configured to receive a water filter and fluidly connect the water filter to the fluid flow path. The filter receiving portion comprises an installation assistance feature. When the water filter is in an installed position, the water filter is fluidly connected to the fluid flow path. The appliance also comprises at least one controller. The controller(s) is configured to receive an indication that the water filter is in a first position. This first position is relative to the filter receiving portion so as to enable initiation of an installation procedure to cause the water filter to move to the installed position. The installation procedure utilizes the installation assistance feature. The controller(s) is also configured to cause, based on the indication that the water filter is in the first position, activation of the installation assistance feature to reposition the water filter from the first position towards the installed position.

In some embodiments, the appliance further comprises one or more water filter sensors configured to sense when the water filter is in a first position. The indication that the water filter is in the first position may be based on sensor data from the water filter sensor(s).

In some embodiments, the appliance further comprises one or more water filter sensors. The controller(s) is further configured to receive an indication from the water filter sensor(s) that the water filter is in the installed position. The controller(s) may be further configured to provide, based on the indication that the water filter is in the installed position, a notification to a user that the water filter is in the installed position. The controller(s) may be further configured to reset, based on the indication that the water filter is in the installed position, at least one of a timer or a count corresponding to an estimated time of replacement for the water filter.

In some embodiments, the appliance is one of a refrigerator, a freezer, a dishwasher, a washing machine, a dryer, a water cooler, a water dispenser, an ice maker, a water heater, or a water purifier.

In some embodiments, the installation assistance feature is configured to move the water filter in a first direction without the water filter rotating relative to the appliance. The installation assistance feature may further comprise a first member. This first member may be configured to rotate about a first axis, and the first member may comprise an inclined track. This inclined track may be configured to receive the water filter. Upon rotation of the first member and the inclined track, the water filter may move along the first axis without rotating relative to the appliance. The installation assistance feature may also comprise a motor and a drive gear, with the motor being configured to operate to cause the drive gear to rotate to cause the rotation of the first member. In some embodiments, either the water filter or the appliance defines a recess configured to receive a corresponding key extending from the other of the water filter or the appliance. When the key is received within the recess, the recess is configured to prevent rotation of the water filter relative to the appliance while the water filter moves to the installed position.

In some embodiments, the appliance further comprises one or more water filter sensors. The controller(s) is configured to determine, based on sensor data from the water filter sensor(s), if the water filter being used is approved. The controller(s) is configured to adversely affect operation of the appliance if the water filter is not approved. The appliance may further comprise a valve, and this valve may be configured to limit flow of fluid along the fluid flow path if the water filter is not approved.

In some embodiments, the filter receiving portion comprises a magnetic material. This magnetic material of the filter receiving portion is configured to form a magnetic bond with the water filter when the water filter is in the first position. The filter receiving portion may also comprise a disengagement member. The disengagement member is configured to apply a force to displace the water filter from the installed position. The filter receiving portion may also comprise an electromagnet containing the magnetic material. The electromagnet may be configured to generate a magnetic field when electrical current is provided to the electromagnet. The electromagnet may be configured to generate no magnetic field when electrical current is not provided to the electromagnet, and the controller(s) may be configured to control provision of electrical current to the electromagnet.

In some embodiments, the appliance further comprises one or more water filter sensors. The controller(s) may be configured to provide, after receiving an indication from the water filter sensor(s) that the water filter is in an installed position, an indication to a user that the water filter is in the installed position. This may be done by performing at least one of the following actions: (a) sending a signal to a display on the appliance; (b) sending a notification to another device; (c) causing a light on the appliance to be turned on or change color; (d) causing a sound to be generated by the appliance; or (e) causing vibration of the appliance.

In another example embodiment, a filter receiving portion for receiving a water filter is provided. The filter receiving portion comprises an installation assistance feature. When the water filter is in an installed position, the water filter is fluidly connected to a fluid flow path. The filter receiving portion also comprises at least one controller. The controller(s) is configured to receive an indication that the water filter is in a first position. This first position is relative to the filter receiving portion so as to enable initiation of an installation procedure to cause the water filter to move to the installed position. The installation procedure utilizes the installation assistance feature. The controller(s) are also configured to cause, based on the indication that the water filter is in the first position, activation of the installation assistance feature to reposition the water filter from the first position towards the installed position.

In some embodiments, the controller(s) may be further configured to receive an indication from the water filter sensor(s) that the water filter is in the installed position. The controller(s) may be further configured to provide, based on the indication that the water filter is in the installed position, a notification to a user that the water filter is in the installed position.

In some embodiments, the controller(s) is further configured to reset, based on the indication that the water filter is in the installed position, at least one of a timer or a count corresponding to an estimated time of replacement for the water filter.

In some embodiments, the installation assistance feature is configured to move the water filter in a first direction without the water filter rotating. The installation assistance feature may further comprise a first member. This first member may be configured to rotate about a first axis. The first member may comprise an inclined track, and the inclined track may be configured to receive the water filter. Upon rotation of the first member and the inclined track, the water filter may move along the first axis without rotating. The installation assistance feature may further comprise a motor and a drive gear, with the motor being configured to operate to cause the drive gear to rotate to cause the rotation of the first member. The filter receiving portion may also define a recess configured to receive a key extending from a surface of the water filter. The key may be received within the recess, and the recess may be configured to prevent rotation of the water filter while the water filter moves to the installed position.

In yet another example embodiment, a system is provided. This system comprises an appliance comprising a fluid flow path. The system also comprises a water filter and a filter receiving portion. The filter receiving portion is configured to receive the water filter and fluidly connect the water filter to the fluid flow path. The filter receiving portion comprises an installation assistance feature. When the water filter is in an installed position, the water filter is fluidly connected to the fluid flow path. The system also comprises at least one controller. The controller(s) is configured to receive an indication that the water filter is in a first position. This first position is relative to the filter receiving portion so as to enable initiation of an installation procedure to cause the water filter to move to the installed position. The installation procedure utilizes the installation assistance feature. The controller(s) is configured to cause, based on the indication that the water filter is in the first position, activation of the installation assistance feature to reposition the water filter from the first position towards the installed position.

In yet another example embodiment, a water filter is provided. The water filter comprises a water inlet, a water outlet, and a filter fluid path extending from the water inlet to the water outlet. The water filter also comprises one or more filter elements in the filter fluid path and one or more engagement elements. The water filter is configured to be received within a filter receiving portion at a first position. The one or more engagement elements are configured to receive a force from the filter receiving portion so as to cause the water filter to move to an installed position in an appliance. When the water filter is in the installed position, the water filter is fluidly connected to a fluid flow path of the appliance. In some embodiments, the water filter may comprise a magnetic material. In some embodiments, the water filter comprises a key on a first surface of the water filter. The key is configured to be received within a recess defined within the filter receiving portion. The key is configured to, in conjunction with the recess, prevent rotation of the water filter as the water filter is moved to the installed position.

In some embodiments, the water filter comprises a recess on a first surface of the water filter. The recess is configured to receive a key extending from the filter receiving portion. The recess is also configured to, in conjunction with the key, prevent rotation of the water filter as the water filter is moved to the installed position.

In some embodiments, the water filter further comprises a tracking unit. This tracking unit may be selected from the group consisting of an RFID tag, an RTLS tag, a beacon, or a transmitter. A controller may be configured to receive information from the tracking unit through at least one of RFID, ultra wide-band RTLS, Wi-Fi RTLS, infrared RTLS, Bluetooth, Bluetooth Low Energy (“BLE”), or Wi-Fi.

### BRIEF DESCRIPTION OF THE DRAWINGS

Having thus described the invention in general terms, reference will now be made to the accompanying drawings, which are not necessarily drawn to scale, and wherein:

FIG. 1 illustrates an example appliance, in accordance with some embodiments discussed herein;

FIG. 2 illustrates a cross sectional, schematic view of a portion of the example appliance shown in FIG. 1 showing a fluid flow path, a filter receiving portion, and a water filter in an installed position, in accordance with some embodiments discussed herein;

FIG. 3A illustrates a perspective view of a portion of an example water filter, in accordance with some embodiments discussed herein;

FIG. 3B illustrates a side view of the portion of the example water filter shown in FIG. 3A, in accordance with some embodiments discussed herein;

FIG. 4A illustrates a perspective view of an example first member of a filter receiving portion, in accordance with some embodiments discussed herein;

FIG. 4B illustrates a top view of the example first member shown in FIG. 4A, in accordance with some embodiments discussed herein;

FIG. 4C illustrates a cross-sectional view of the example first member shown in FIG. 4A taken along line 4C-4C, in accordance with some embodiments discussed herein;

FIG. 4D illustrates a perspective view of an example installation assistance feature of a filter receiving portion, in accordance with some embodiments discussed herein;

FIG. 5A shows a perspective view of an example water filter received within an example first member of a filter receiving portion, wherein the water filter is in a first position, in accordance with some embodiments discussed herein;

FIG. 5B shows a perspective view of the water filter and the first member shown in FIG. 5A, where the water filter is in an installed position, in accordance with some embodiments discussed herein;

FIG. 6 illustrates a cross sectional view of an example filter receiving portion, in accordance with some embodiments discussed herein;

FIG. 7A shows a perspective view of an example water filter received within an example filter receiving portion, wherein the water filter is in a first position, in accordance with some embodiments discussed herein;

FIG. 7B shows a perspective view of the water filter and filter receiving portion shown in FIG. 7A, wherein the water filter is received within the filter receiving portion and wherein the water filter is in an installed position, in accordance with some embodiments discussed herein;

FIG. 8A shows a perspective view of an example valve assembly in a closed state, in accordance with some embodiments discussed herein;

FIG. 8B shows a side view of the valve assembly shown in FIG. 8A where the valve assembly is in a closed state, in accordance with some embodiments discussed herein;

FIG. 8C shows a perspective view of the valve assembly shown in FIG. 8A where the valve assembly is in an open state, in accordance with some embodiments discussed herein;

FIG. 8D shows a side view of the valve assembly shown in FIG. 8A where the valve assembly is in an open state, in accordance with some embodiments discussed herein;

FIG. 9 shows a side view of an example filter receiving portion, wherein the filter receiving portion comprises a disengagement member, in accordance with some embodiments discussed herein;

FIG. 10 illustrates a block diagram of a system that includes an appliance and a water filter, such as utilized in various embodiments discussed herein;

FIG. 11 is a flowchart illustrating an example method for installing a water filter, in accordance with some embodiments discussed herein; and

FIG. 12 is a flowchart illustrating an example method for adjusting the flow of fluid based on the type of installed water filter, in accordance with some embodiments discussed herein.

### DETAILED DESCRIPTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

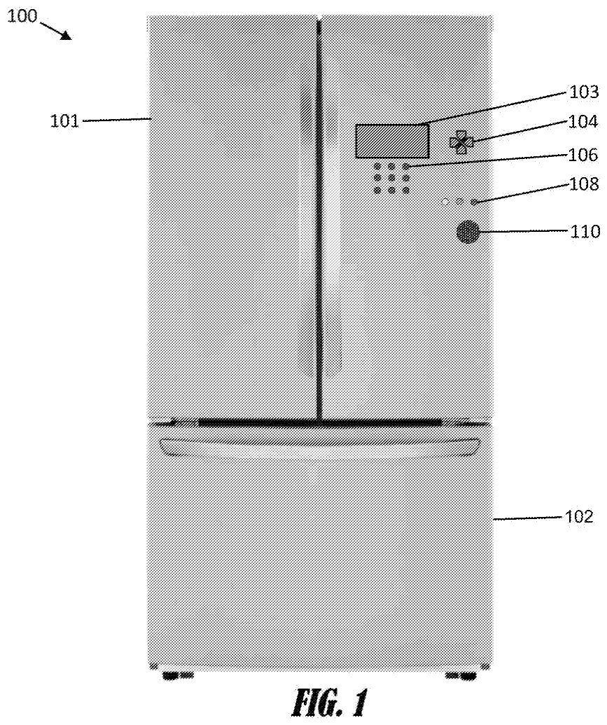

As depicted in FIG. 1, an example appliance 100 is shown as a combination of a refrigerator 101 and a freezer 102. However, in other embodiments, other appliances may also be utilized. These other appliances include, but are not limited to, a refrigerator, a freezer, a dishwasher, a washing machine, a dryer, a water cooler, or a water purifier. Additionally, the embodiments described herein may be utilized in other systems such as commercial or industrial equipment.

The appliance 100 comprises a display 103, and the display 103 may present information about the operation of the appliance 100 to a user. Directional input buttons 104 are also provided, and these may permit a user to navigate through various screens on the display 103. Input buttons 106 are also provided, and these input buttons 106 may permit a user to select an option on the display 103 or to select a desired mode of operation. The appliance 100 may also comprise three lights 108. As shown in FIG. 1, the three lights 108 are in three different colors, with one light turned off, a second light lit up in green, and a third light in red. The use of different colors for the lights 108 may be utilized to convey information to the user. However, in other embodiments, one or more lights 108 may be permitted to only switch on and off without being able to present different colors when turned on. The appliance 100 also comprises a speaker 110, and this speaker may cause a sound to be generated by the appliance. In other embodiments, the appliance 100 may comprise a different number of these components or the appliance 100 may comprise additional components/features.

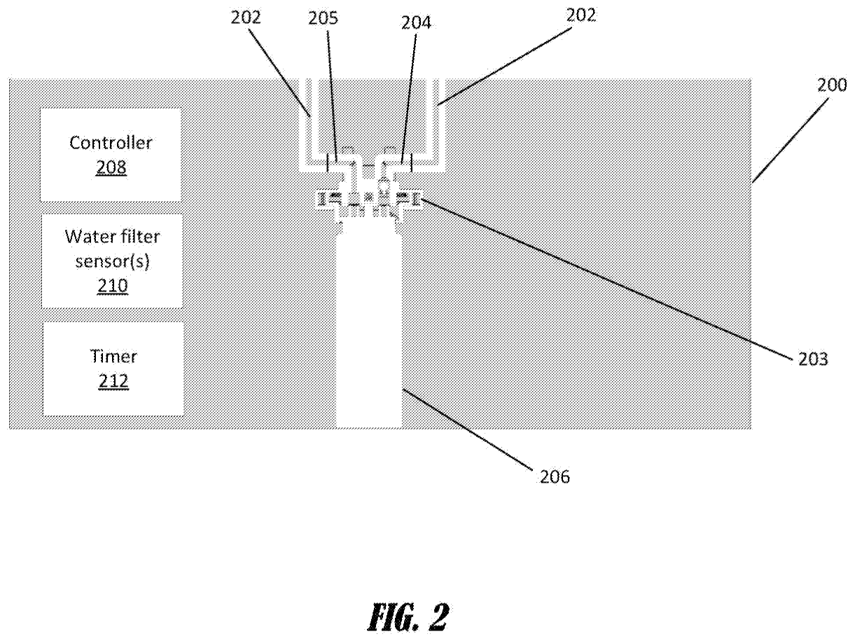

FIG. 2 illustrates a cross sectional, schematic view of the example appliance 200. The appliance 200 may comprise a fluid flow path 202. A filter receiving portion 203 may be formed as part of the appliance 200, or the filter receiving portion 203 may be a component that can be easily installed and removed from the appliance 200. The filter receiving portion 203 may comprise an inlet line 204 and an outlet line 205 that may be configured to be installed as shown in FIG. 2 so that the inlet line 204 and outlet line 205 are both fluidly connected with the fluid flow path 202 of the appliance 200. The filter receiving portion 203 may be configured to receive the water filter 206 and fluidly connect the water filter 206 to the fluid flow path 202. In such a regard, water may pass through an installed water filter 206 to form filtered water that may be utilized with the appliance, such as with respect to various features for the appliance (e.g., provide drinking water to a user through a dispensing outlet, provide ice to the user, etc.).

As described herein, the filter receiving portion 203 may also comprise an installation assistance feature that may assist with moving the water filter 206 into the installed position so that the water filter 206 is fluidly connected to the fluid flow path 202.

The appliance 200 may comprise at least one controller 208, and the at least one controller 208 may be configured to execute instructions to assist with the installation of the water filter 206, among other features of the appliance. The at least one controller 208 may receive an indication that the water filter 206 is in a first position. The at least one controller 208 may receive this indication from a water filter sensor 210 or multiple water filter sensors 210 configured to detect when the water filter 206 is in the first position. However, the at least one controller 208 may receive this indication via other means as well. In this regard, in some embodiments, the indication may come from user input indicating a desire to initiate an installation procedure (e.g., a user may press a “start” button, provide a verbal instruction, etc.). In some embodiments, there may be no sensor data associated with the water filter being in the first position and, instead, the controller may initiate the installation procedure purely based on user input. Based on the indication that the water filter 206 is in the first position, the at least one controller 208 may cause activation of the installation assistance feature to reposition the water filter 206 from the first position towards the installed position.

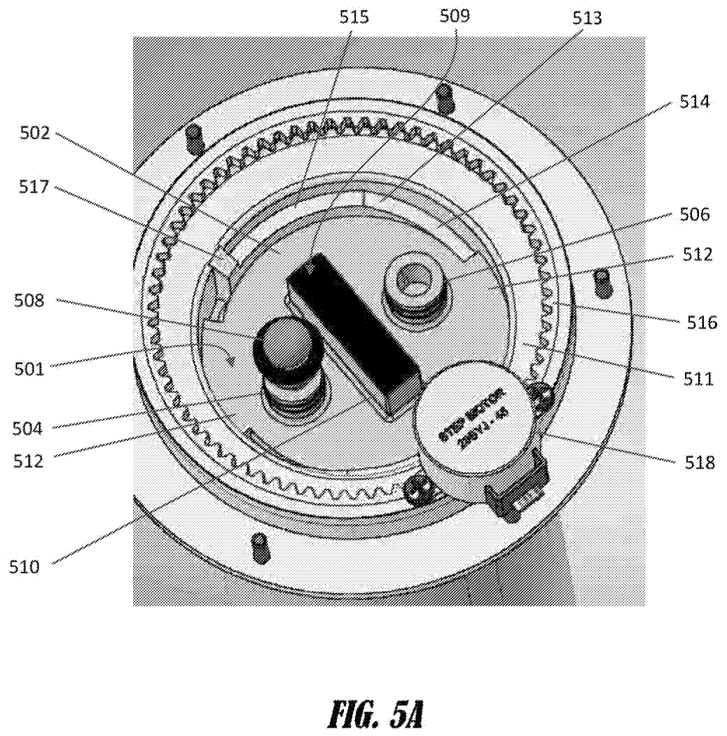

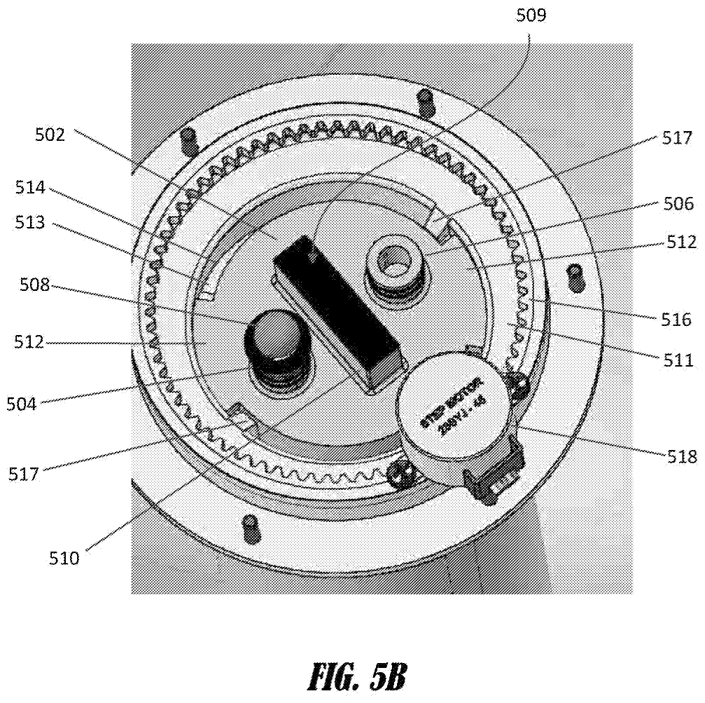

The one or more water filter sensors 210 may be configured to sense various circumstances corresponding to the water filter 206. For example, the one or more water filter sensors 210 may be configured to sense when the water filter 206 is in a first position. At the first position, the water filter 206 is relative to the filter receiving portion 203 so that installation procedure may be initiated. For example, when the water filter 206 is in the first position, such as described with respect to FIG. 5A, one or more engagement features may be positioned so as to be able to receive an inclined track of the first member of the filter receiving portion. This installation procedure may utilize the installation assistance feature and may cause the water filter 206 to move from the first position to the installed position.

The one or more water filter sensors 210 may also be configured to detect when the water filter 206 is in the installed position, and the at least one controller 208 may be configured to receive an indication from the one or more water filter sensors 210 that the water filter 206 is in the installed position. The at least one controller 208 may also be configured to provide a notification to the user accordingly. Additionally or alternatively, the at least one controller 208 may be configured to provide a notification to a user regarding various other circumstances that can be sensed by the one or more water filter sensors 210, such as that the water filter 206 is in the first position, that the water filter 206 is being removed or installed, or if no water filter 206 is present. The at least one controller 208 may be configured to provide this notification by causing (a) a signal to be sent to a display 103 (FIG. 1) of the appliance 100; (b) a light 108 on the appliance 100 to be turned on or to change in color, (c) the generation of a sound in the appliance 100 that is communicated by the speaker 110; (d) a vibration of the appliance 100; or (e) a notification to be sent to another device to notify the user. However, this notification may also be provided in other ways as well.

Additionally, sensors may also be used to assist in identifying various system errors. Different types of system errors may be detected, including, but not limited to, improper filter positioning, excessive contamination in the filter, detection of leakage, and detection of an improper water filter being used. Sensors may also be used to detect that the system is functioning properly, and this may be done by sensing the position of components so that a determination may be made if the components are in the correct position for a given phase (e.g., initial installation position, initial interaction of the track(s) with the water filter, ascension of the water filter, positioning of the water filter into fluid connection, release of the water filter from the receiving portion, descending of the water filter, positioning of the water filter into the release position, etc.). In some embodiments, the one or more sensors could be used to track the position of the water filter or portions of the receiving portion to ensure proper alignment/positioning during installation or removal (e.g., along various phases thereof).

In some embodiments, a controller may be configured to receive data from a sensor about a system error or about the status of the system. The controller may also be configured to either prevent or allow the flow of fluid through the fluid flow path 202. Preventing the flow of fluid may permit a filter to be changed or to prevent leakage in the event that a system error is detected, but the flow of fluid may be stopped for other reasons as well.

The appliance 200 may also comprise a timer 212 or the appliance 200 may comprise a memory where a count is stored. Upon receiving an indication that the water filter 206 is in an installed position, the at least one controller 208 may be configured to reset the timer 212 or the count. This timer 212 or the count may correspond to the estimated time of replacement for the water filter 206.

As described herein, the one or more water filter sensors 210 may be a single sensor or multiple sensors. Further the multiple sensors may be different types of sensors and may be positioned and/or aimed differently depending on the desired circumstance being sensed. In some embodiments, functionality can be shared between sensors and/or multiple sensor data may be utilized to determine occurrence of a circumstance. Various example sensors include infrared sensors, proximity sensors, float sensors, magnetic sensors, chemical sensors, etc.

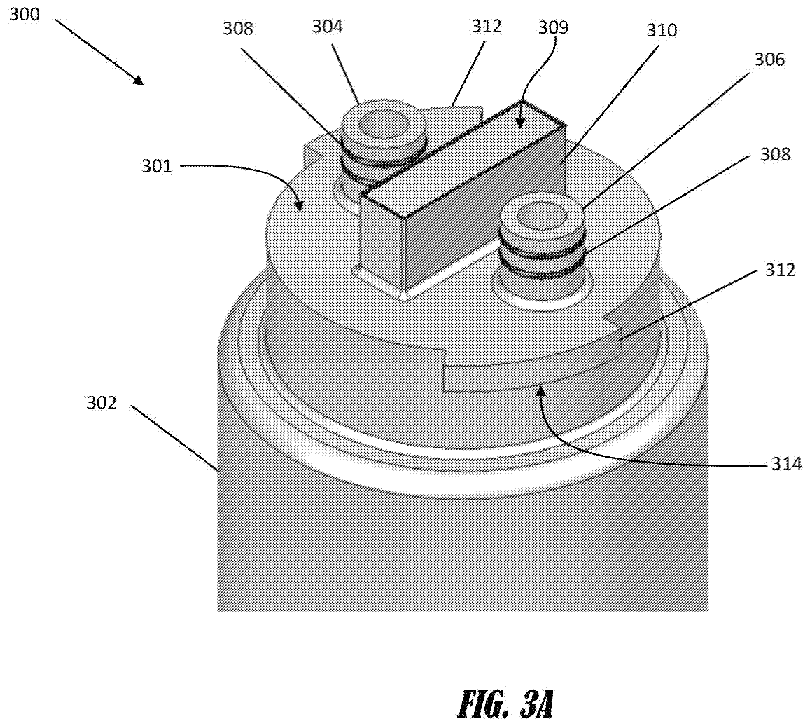

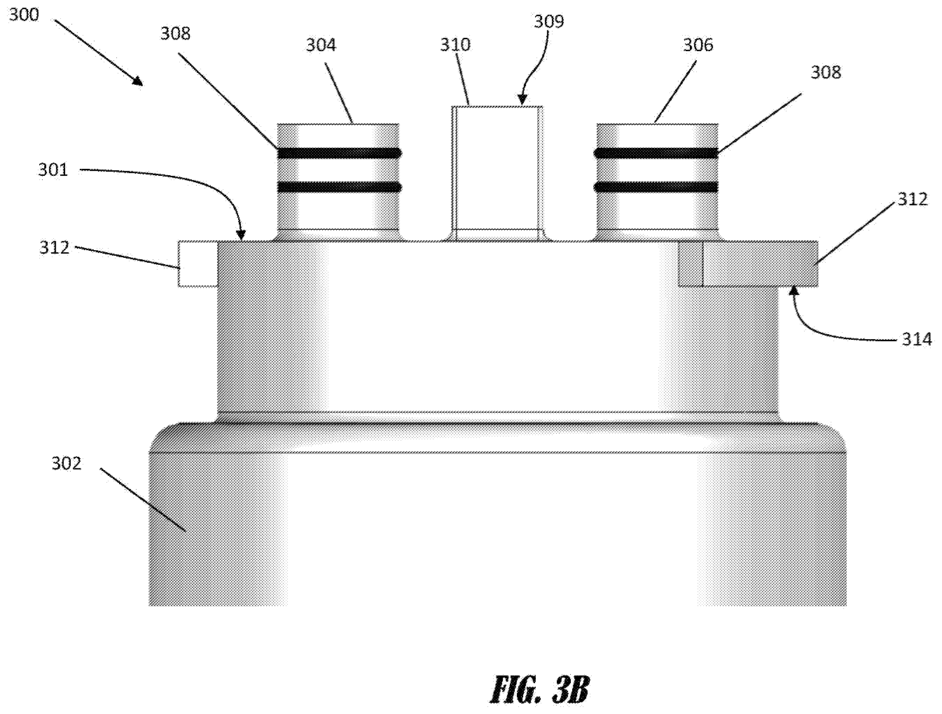

FIGS. 3A and 3B illustrate a portion of an example water filter 300, in accordance with some embodiments discussed herein. FIG. 3A illustrates a perspective view of the example water filter 300 while FIG. 3B illustrates a side view of the example water filter 300. In the embodiment shown, the water filter 300 comprises a first surface 301. A water inlet 304 and a water outlet 306 are located at the first surface 301. A filter fluid path extends within the water filter 300 from the water inlet 304 to the water outlet 306, and this filter fluid path comprises one or more filter elements configured to filter the water to increase purification, such as for drinking purposes. In some embodiments, this filter fluid path extends into the body 302 of the water filter 300. Example filter elements may include one or more physical and/or chemical-based (e.g., carbon) filters for single or staged filtering.

The water filter 300 comprises two O-rings 308 on each of the water inlet 304 and water outlet 306. In other embodiments, the water inlet 304 and water outlet 306 may comprise a different number of O-rings 308, or the water filter 300 may comprise no O-rings 308. O-rings 308 may assist in forming a seal between the water inlet 304 and a filter receiving portion and/or an appliance. O-rings 308 may also assist in forming a seal between the water outlet 306 and a filter receiving portion and/or an appliance.

The water filter 300 comprises a key 310 extending from the first surface 301. This key 310 may be received within a recess defined within an appliance or a filter receiving portion. If the recess is defined within the filter receiving portion, the recess will preferably be defined by a part of the filter receiving portion that is fixed relative to the appliance. When the key 310 is received within such a recess, the recess will preferably be configured to constrain the key 310 so that the rotation of the key 310 is prevented. However, the recess will preferably allow the key 310 to move in directions normal to the first surface 301 of the water filter 300. Where the rotation of the key 310 is prevented, the rotation of the water filter 300 itself is prevented as the key 310 is part of the water filter 300. Thus, the interaction between the key 310 and the recess may allow the water filter 300 to move in directions normal to the first surface 301 of the water filter 300 while preventing the rotation of the water filter 300 relative to the appliance.

While a key 310 is shown in FIGS. 3A and 3B, the rotation of the water filter 300 may be constrained in alternative ways. For example, instead of defining a key extending from the first surface 301, a water filter may instead comprise a first surface 301 that defines a recess, and a key located on the appliance or the filter receiving portion may be received within that recess. In this way, the filter and recess may together constrain the rotation of the water filter. Additionally, in other embodiments, the water inlet 304 and water outlet 306 may extend from the first surface 301 of the water filter 300, and the water inlet 304 and/or the water outlet 306 may effectively serve as a key to constrain rotation of the water filter 300. However, key 310 depicted in FIGS. 3A and 3B will preferably be used to reduce any stress acting on the water inlet 304 and water outlet 306 and to ensure an effective seal for the water inlet 304 and water outlet 306.

In some embodiments, the water filter 300 may comprise a magnetic material in certain areas. For example, magnetic material may be provided at the first surface 309 of the key 310 to form a magnetic bond with a filter receiving portion and to assist with shifting the water filter 300 to an installed position and/or holding the water filter 300 in the first position and/or the installed position. Magnetic material may also be provided at the first surface 301 of the water filter 300. Magnetic material may be provided in the form of an electromagnet or a solenoid. This electromagnet may be configured to generate a magnetic field when electrical current is provided to the electromagnet and the electromagnet may be configured to generate no magnetic field when electrical current is not provided to the electromagnet. A controller may be configured to control the amount of electrical current provided to the electromagnet. An electromagnet may be utilized at various positions in the appliance, the filter receiving portion, or the water filter, and an electromagnet may not be used in some embodiments. While an electromagnet may be used, magnetic material may be provided in other ways as well. For example, permanent magnets or rare earth magnets may be provided.

The water filter 300 also comprises two follower sections 312. The follower sections 312 depicted in FIG. 3A extend radially from the water filter 300. The water filter 300 may be received within a filter receiving portion so that the follower sections 312 may rest on the inclined track of the filter receiving portion. In some embodiments, the bottom surface 314 of follower sections 312 may define a plane that is angled relative to the first surface 301 of the water filter 300. However, in the embodiment shown in FIGS. 3A and 3B, the bottom surface 314 of follower sections 312 define a plane that is parallel to the first surface 301 of the water filter 300. The water filter 300 may comprise magnetic material at the follower sections 312. This magnetic material may be helpful in securing the water filter 300 at a first position within the filter receiving portion so that the installation procedure may be initiated. The follower sections 312 may serve as engagement elements that may receive a force from another component (e.g., the inclined track of the filter receiving portion) to cause the follower sections 312 and the connected water filter 300 to move from a first position towards an installed position or from an installed position towards a first position. Follower sections 312 may also be used as keys to ensure that the filter is installed in the correct position.

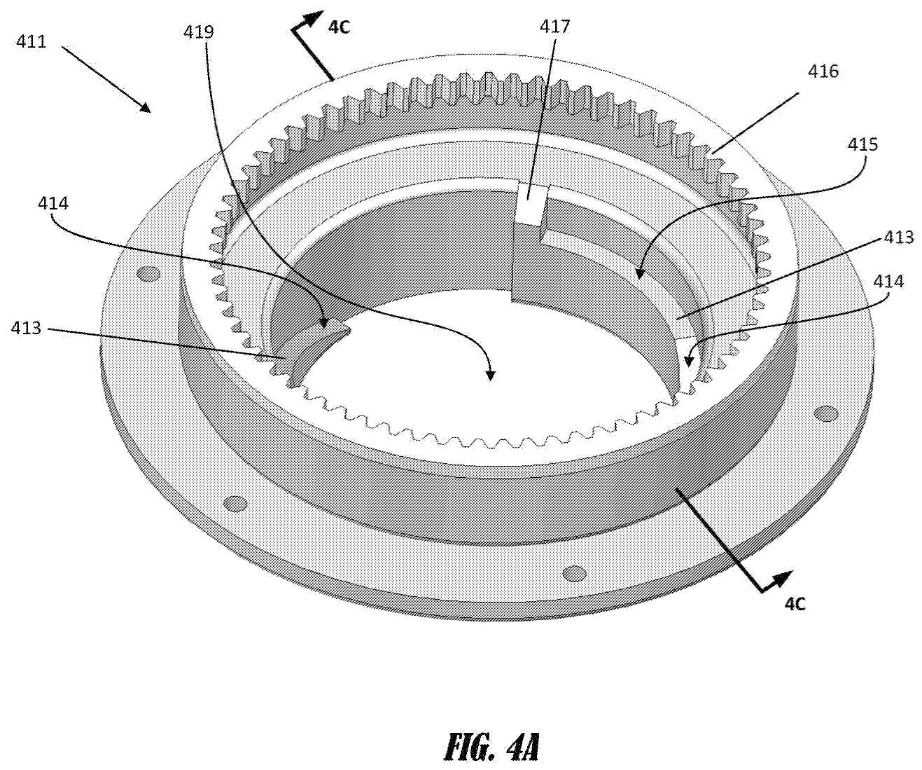

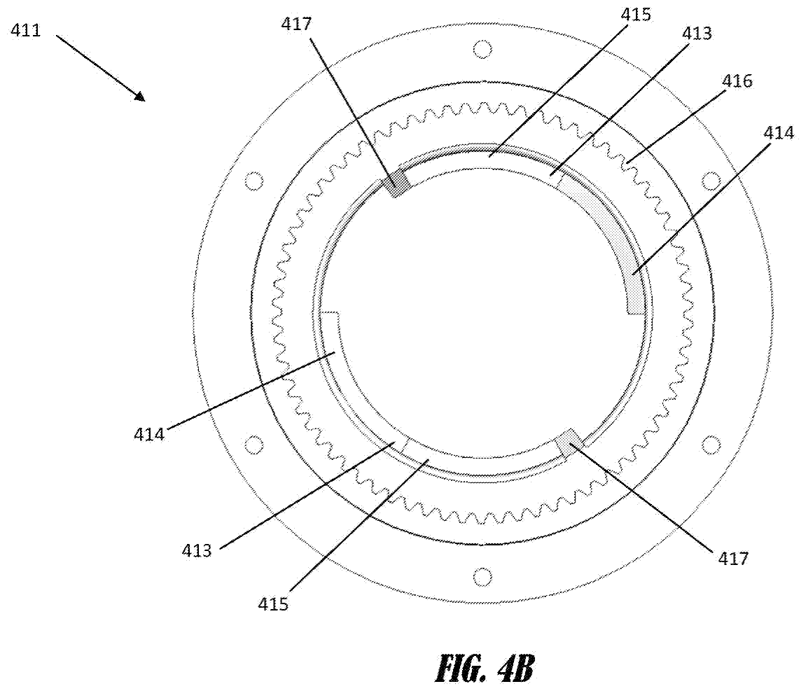

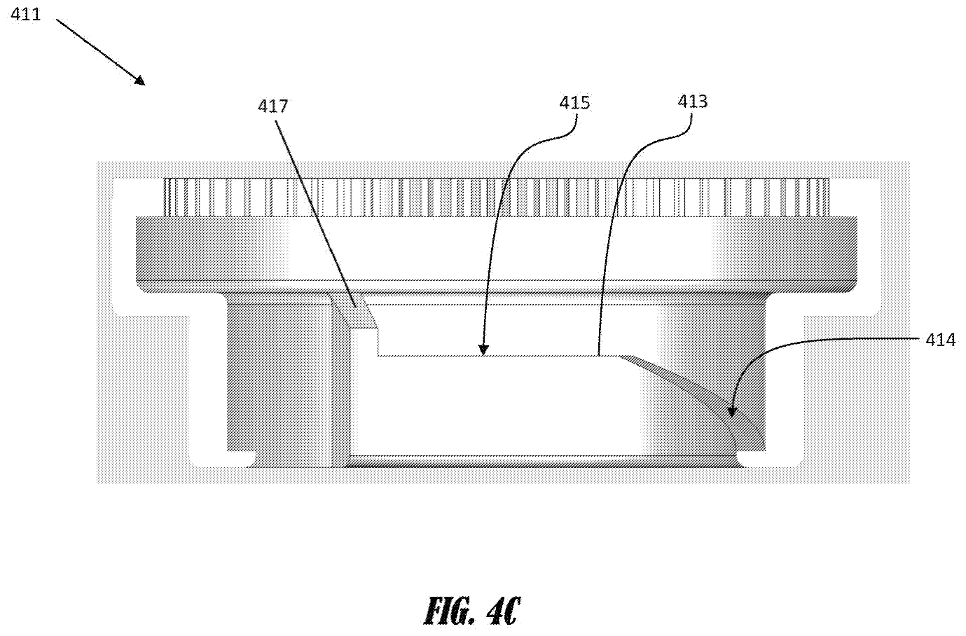

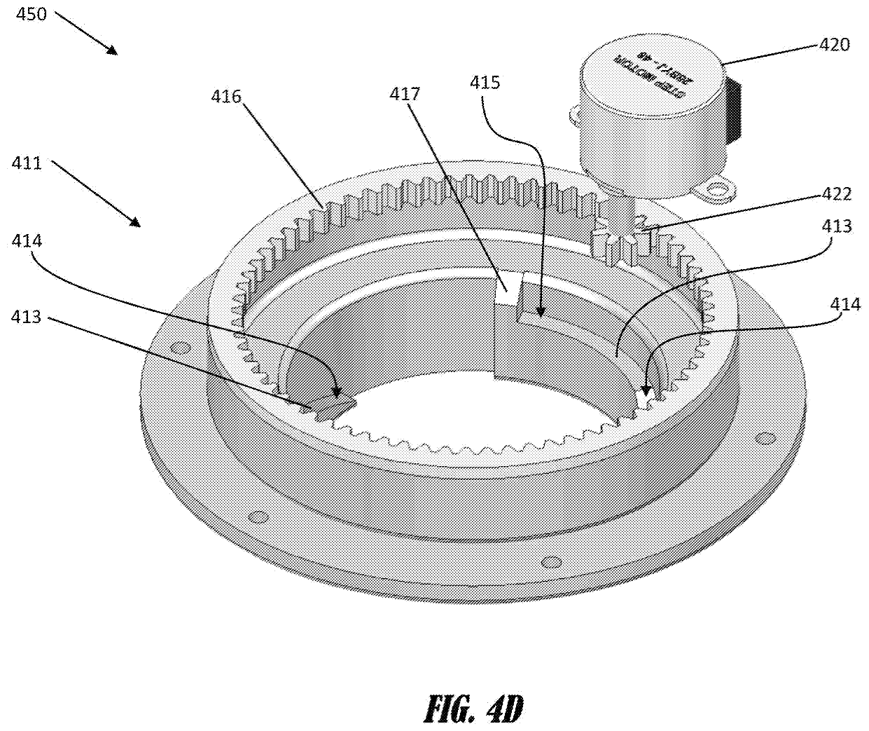

FIGS. 4A, 4B, 4C, and 4D illustrate various views of an example first member 411. FIG. 4A shows a perspective view of an example first member 411, FIG. 4B shows a top view of the first member 411 shown in FIG. 4A, and FIG. 4C shows a cross sectional view of the first member 411 shown in FIG. 4A. FIG. 4D shows a perspective view of an example installation assistance feature 450 comprising a motor 420 and a drive gear 422 in communication with the example first member 411 of FIG. 4A. While FIG. 4B is described as a top view of the first member 411 of FIG. 4A, the first member 411 may be oriented in different manners.

The first member 411 may possess a largely circular shape and may define a hole 419 extending therethrough for receiving the water filter (e.g., the first member 411 may be annularly-shaped). In the illustrated embodiment, the first member 411 comprises two inclined tracks 413 within the interior of the first member 411. However, in other embodiments, a different number of inclined tracks may be included. The first member 411 will preferably comprise at least one inclined track 413 for each follower section 312 (FIG. 3A) that is present on a water filter 300. The hole 419 within the first member 411 may be configured to have a size that will enable a water filter 300 to be received within the recess and that will enable the follower sections 312 of the water filter 300 to fit in the hole before the start of an inclined track 413.

The inclined tracks 413 may possess a varying slope in some embodiments. As shown in FIGS. 4A-4D, the first surface 415 of the inclined track 413 possesses no slope while the second surface 414 possesses a slope. However, in other embodiments, the inclined track 413 may comprise a uniform slope or the slope may change, such as according to a continuous function. A wall 417 may be provided to prevent additional rotation of the first member with respect to the water filter 300 once the water filter 300 has moved to the installed position (as the follower sections 312 travel up the inclined tracks 413).

The first member 411 may also comprise gear teeth 416. In the embodiment shown, gear teeth 416 are provided in an internal part of the first member 411. However, in other embodiments, these gear teeth 416 may extend outwardly from the first member 411.

As shown in FIG. 4D, a drive gear 422 may interact with the gear teeth 416, and this drive gear 422 may be driven by the motor 420. The first member 411, the drive gear 422, and the motor 420 may together create an installation assistance feature 450. This installation assistance feature 450 may be part of the filter receiving portion 600 (e.g., shown in part in FIG. 6). The motor 420 may be a step motor, although other types of motors are contemplated. In the embodiments shown, the motor 420 may be relatively fixed and cause rotation of the drive gear 422. This rotation of the drive gear 422 may in turn interact with the gear teeth 416, causing rotation of the first member 411 and the connected inclined track 413 about a central axis of the first member 411. Thus, activation of the motor 420 may cause the inclined track 413 to rotate. When a water filter 300 is received within the internal hole 419 defined within the first member 411, the inclined tracks 413 may move underneath the follower sections 312 and cause the water filter 300 to move upwardly as the follower sections 312 ride along the inclined tracks 413 (as they are further rotated). In this regard (and due to the interaction of the key and recess), the installation assistance feature 450 may be configured to move the water filter 300 along the central axis of the first member 411 without rotating.

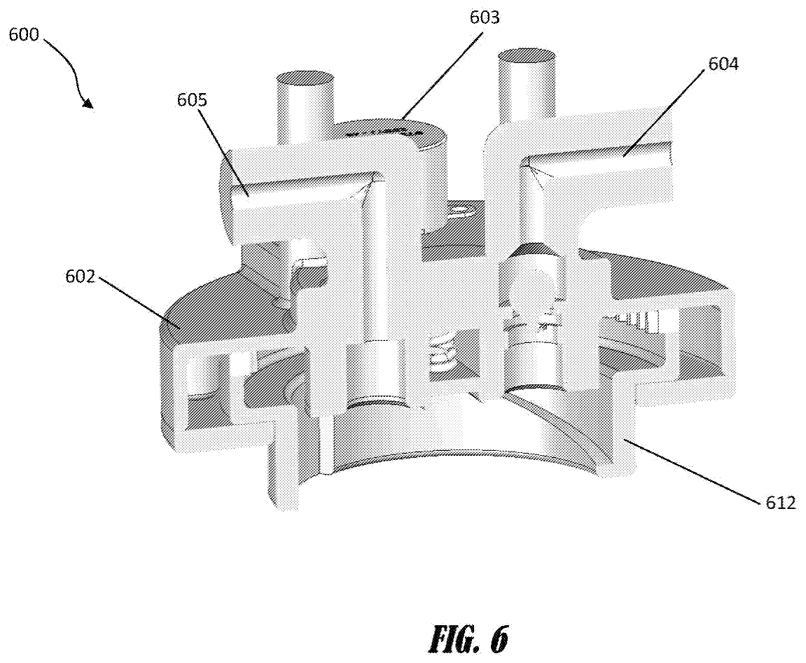

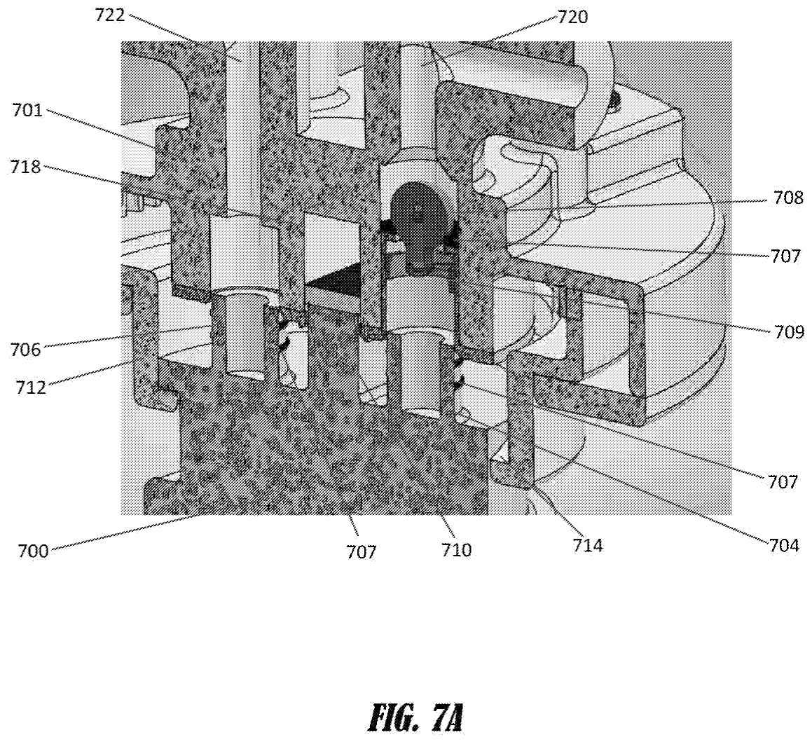

FIGS. 5A-5B illustrate perspective views of a water filter 502 received within a first member 511. In FIG. 5A, a water filter 502 is at a first position on the inclined track 513, and, in FIG. 5B, the water filter 502 is in a second position on the inclined track. Notably, FIGS. 5A and 5B present additional components such as the valve 508 (which is part of the filter receiving portion (as shown in FIGS. 6, 7A, and 7B) and the motor 518.

The water filter 502 operates similarly to the water filter 300 presented in FIGS. 3A and 3B and discussed above. The first member 511 operates similarly to the first member 411 presented in FIGS. 4A-4D and discussed above. At least one controller may assist in controlling an installation assistance feature 450 (FIG. 4D) using the components shown in FIG. 5A-5B. While the motor 518 may cause the rotation of the first member 511 and the inclined track 513, the water filter 502 may be configured so that it may not rotate. This feature may result from the key 510 being received within a recess as described above. Thus, as the inclined track 513 rotates, the inclined track 513 may cause the water filter 502 to move in a direction normal to the first surface 501 of the water filter 502. Thus, the installation assistance feature 450 (FIG. 4D) is configured to move the water filter 502 in a first direction without the water filter 502 rotating relative to the appliance. However, these constraints may be accomplished in other ways.

For example, in FIG. 5A, where the first member 511 is oriented vertically, activation of the motor 518 in a first mode may cause the first member 511 to rotate in a clockwise direction. Thus, the inclined track 513 will rotate in a clockwise direction underneath the follower section 512 of the water filter 502. Because the rotation of the water filter 502 is constrained, the water filter 502 may move from the first position in FIG. 5A to the second position shown in FIG. 5B. The water filter 502 may move back to the first position by activating the motor 518 in a second mode to cause the first member 511 to rotate in a counterclockwise direction (e.g., gravity and/or one or more disengagement members may enable/force the water filter 502 to move back to the first position, such as down the inclined tracks). While the embodiments shown in FIGS. 5A and 5B are oriented vertically, the orientation may be changed in other embodiments. Additionally, the first surface 509 of the key 510 may comprise magnetic material.

While an example installation assistance feature 450 is described above that utilizes a motor 420 and a drive gear 422, other actuation methods and components may be utilized. For example, a system of belts and chains may be used, a worm gear system may be used, or electrical, electromagnetic, or magnetic actuation components may be provided. However, other approaches may be used as well.

FIG. 6 illustrates a cross sectional view of an example filter receiving portion 600, in accordance with some embodiments discussed herein. This filter receiving portion 600 may serve as a manifold that may fluidly connect a filter fluid path 202 of a water filter 206 (FIG. 2) to a fluid path within an appliance 200. The filter receiving portion 600 may also comprise a first member 612 and a second member 602, and a motor 603 may be fixed to the second member 602. The first member 612 is similar to the first member 411 presented within FIGS. 4A-4C, and the first member 612 may rotate relative to the motor 603 and the second member 602. The second member 602 may comprise the water inlet 604 and the water outlet 605, which may both serve to fluidly connect a water filter 206 (FIG. 2) to an appliance 200 when the water filter 206 is in an installed position.

FIGS. 7A and 7B illustrate a cross-sectional view of an example water filter 700 and an example filter receiving portion 701 and first member 712. The water filter 700 may operate similarly to the water filter 300 shown in FIG. 3. This water filter 700 may comprise a water inlet 704 and a water outlet 706, and O-rings 707 may be included on the external surfaces of water inlet 704 and water outlet 706. These O-rings 707 may assist in forming a seal between (a) the water inlet 704 and the inlet line 720, and (b) the water outlet 706 and the outlet line 722.

The filter receiving portion 701 may comprise an inlet line 720 and an outlet line 722, and the inlet line 720 and outlet line 722 may both be connected to a fluid flow path 202 (FIG. 2) within an appliance 200. In FIGS. 7A and 7B, the inlet line 720 comprises a valve assembly. In this example, the valve assembly comprises a valve seal 707, a valve stopper 708, and a valve lock 709. The valve stopper 708 and the valve lock 709 may be connected so that they move together, and, where the valve lock 709 is oriented vertically as shown in FIGS. 7A and 7B, the valve stopper 708 and valve lock 709 may move vertically relative to the valve seal 707. However, other valve assemblies may be provided that do not use a valve seal 707, a valve stopper 708, and/or a valve lock 709. For example, one alternative valve assembly may provide a wall that may slide to a first “closed” position to block flow, and this wall may slide to a second “open” position to allow flow through the valve. In another example embodiment, a valve may comprise a wall that simply rotates from one position to a second position, with the first position being configured to prevent any flow through the valve and with the second position being configured to permit flow through the valve. Valves may be controlled electronically.

The valve assembly may be configured so that it is biased to a closed state (such as due to the pressure/force of the water flowing through the inlet line 720 and/or due to other forces, such as gravity, bias from a spring, another bias, etc.). In some embodiments, a solenoid valve may be used. In FIG. 7A, the water filter 700 is shown in a first position so that the water inlet 704 is not in contact with the valve lock 709 of the valve assembly, and the valve stopper 708 is pressed against the valve seal 707 to limit or to adversely affect the flow of fluid from the inlet line 720. In some embodiments, this valve assembly may completely prevent the flow of fluid from the inlet line 720 through the valve assembly. In FIG. 7B, the water filter 700 rests in a second position so that the water inlet 704 is in contact with the valve lock 709 of the valve assembly. This contact may force the valve lock 709 and the connected valve stopper 708 upward, creating an opening between the valve stopper 708 and the valve seal 707 so that fluid may flow from the inlet line 720 into the water inlet 704.

Additionally, the filter receiving portion 701 may comprise a recess 718. This recess 718 may be configured so that a key 710 of a water filter 700 may be received within the recess 718. The recess 718 may prevent the rotation of the key 710 when the key 710 is received at least partially within the recess 718 while still allowing the key 710 to shift within the recess 718 (e.g., move further into the recess 718). In this regard, the recess 718 may be elongated such that there is space for the key 710 to be engaged with the recess 718 during movement of the water filter 700 to and from the installed position. The recess 718 may comprise a magnetic material, and this magnetic material may be configured to form a magnetic bond with magnetic material within the key 710. However, magnetic material may also be included in other portions of the filter receiving portion 701, and, in some embodiments, no magnetic material is used.

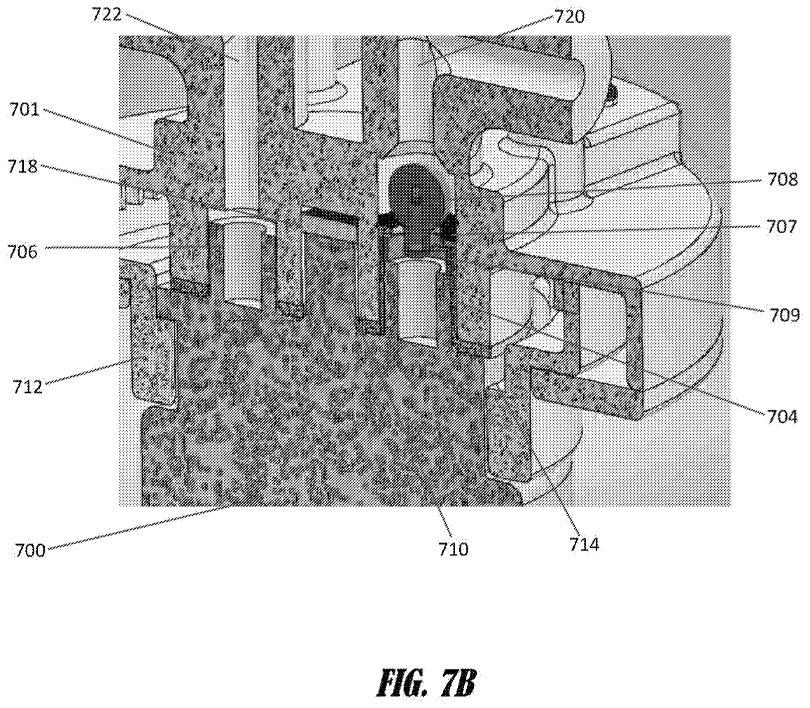

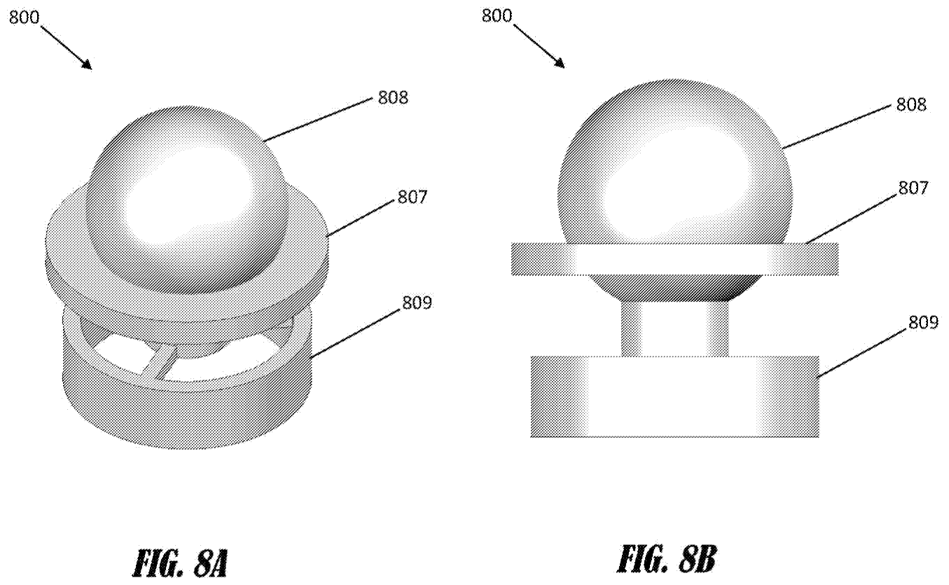

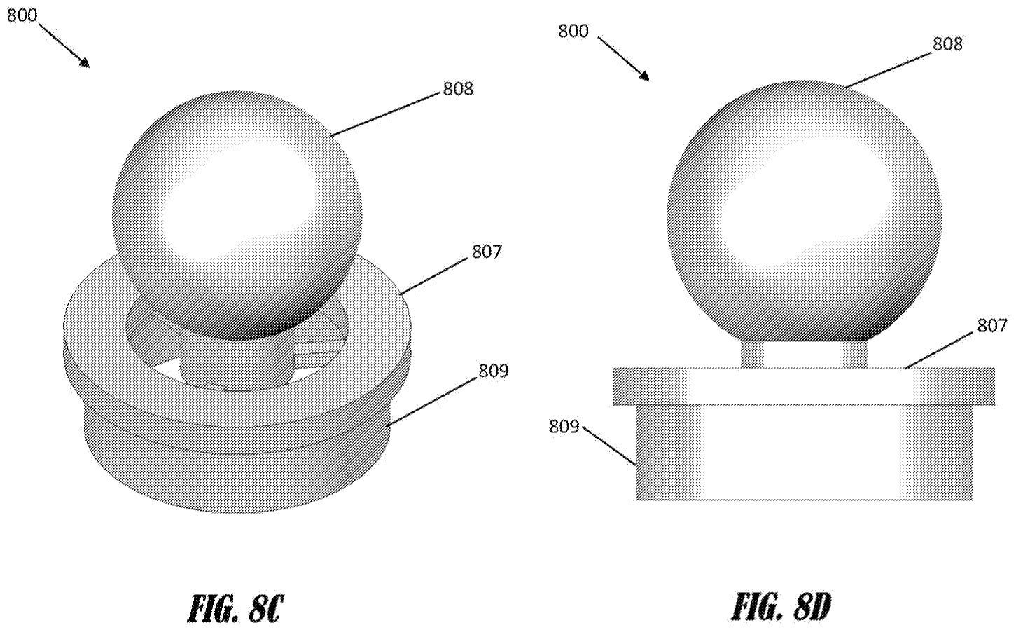

FIG. 8A-8D illustrate various views of an example valve assembly 800. FIGS. 8A and 8B show the valve assembly 800 in a closed state while FIGS. 8C and 8D show the valve assembly 800 in an open state. The valve assembly 800 may comprise a valve seal 807, a valve stopper 808, and a valve lock 809. The valve stopper 808 and the valve lock 809 may be connected so that they move together, and, where the valve lock 809 is oriented vertically as shown in FIGS. 8A-8D, the valve stopper 808 and valve lock 809 may move vertically relative to the valve seal 807.

The valve stopper 808 and the valve lock 809 may be biased to the closed position shown in FIGS. 8A and 8B (such as due to the pressure/force of the water flowing through the inlet line and/or due to other forces, such as gravity, another bias, etc.). However, the water inlet 704 (FIG. 7B) or some other object may come into contact with the valve lock 809 to push the valve lock 809 out of this closed position. For example, where the valve assembly is oriented vertically as shown in FIGS. 8A-8D, the water inlet 704 (FIG. 7B) may push the valve lock 809 upward to force the valve stopper 808 into the open position shown in FIGS. 8C and 8D. Notably, other types of valves and valve assemblies are contemplated for use with various example embodiments described herein.

In some embodiments, the system may be configured to shut off fluid flow for various reasons, such as to protect against leaks or contaminants entering the fluid flow path and/or to allow the filter to be changed without fluid flowing through at the installation position for the filter, among other reasons. In some embodiments, one or more sensors may be configured to sense such a circumstance and the controller may be configured to cause one or more valves (e.g., the valve assembly) to move to a closed state to prevent fluid flow therethrough.

In some embodiments, a disengagement member may be used to disengage the water filter from the installed position within the filter receiving portion. Such a disengagement may occur in conjunction with or after the utilization of the installation assistance feature to release the water filter from the installed position (e.g., rotating the first member such that the inclined tracks rotate relative to the follower sections—providing a downward slope for the follower sections). Once the water filter is moved back to the first position and the inclined tracks are free from the follower sections, the water filter can be removed. In some embodiments, no disengagement member may be used, and other forces, such as gravity may perform a similar operation. In some embodiments where magnetic material is used to assist in engagement between the water filter and the filter receiving portion, the degree of magnetic connection may be configured so as to enable disengagement from the installed position and removal of the water filter, such as via a slight force provided by the user.

In some embodiments, the system may be configured, such as via the at least one controller, to initiate a removal procedure (such as utilizing the disengagement member and/or by reversing operation of the installation assistance feature). In some embodiments, such a removal procedure may be performed in response to user input (e.g., the user pressing a corresponding button or providing verbal instructions, etc.).

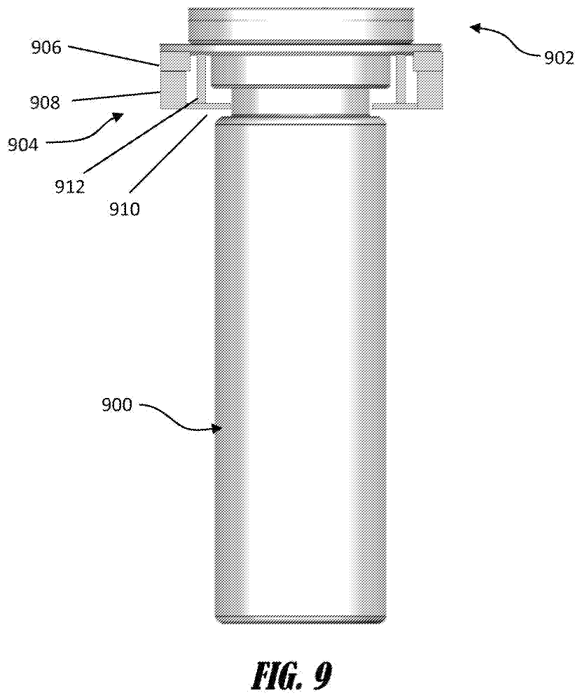

FIG. 9 illustrates a side view of a water filter 900 and a filter receiving portion 902 comprising an example disengagement member 904. The disengagement member 904 may comprise a static portion 906, a dynamic portion 908, and a lever 910. The dynamic portion 908 may shift up and down relative to the static portion 906, and the lever 910 may be attached to the dynamic portion 908.

The disengagement member 904 may also comprise a piston 912. This piston 912 may be a pneumatic piston or a hydraulic piston. By controlling the fluid within piston 912, the piston 912 may exert a force upon the lever 910. For example, where the filter receiving portion 904 is oriented vertically as shown in FIG. 9, the piston 912 may exert an upward or downward force on the lever 910. Thus, the piston 912 may cause the lever 910 to exert a downward force on the water filter 900 to assist in separating the water filter 900 from the filter receiving portion 902. Thus, the disengagement member 904 may assist in overcoming a magnetic bond between magnetic material in the first surface 309 (FIG. 3A) of the key 310 or the first surface 301 of the water filter 300 and the magnetic material at the recess 718 defined within the filter receiving portion 701. In some embodiments, piston 912 may exert a force directly on the filter to eject the filter. The piston 912 may also be used to move the filter to the installed position.

Alternatively or in addition to the disengagement member 904, magnetic material may be provided in the form of an electromagnet so that a magnetic bond may be easily controlled. This electromagnet may be configured to generate a magnetic field when electrical current is provided to the electromagnet, and the electromagnet may be configured to generate no magnetic field when electrical current is not provided to the electromagnet. A controller may be configured to control the amount of electrical current provided to the electromagnet. An electromagnet may be utilized at various positions in the appliance 100 (FIG. 1), the filter receiving portion 902, or the water filter 900, and an electromagnet may not be used in some embodiments.

In the embodiment shown in FIG. 9, the water filter 900 and disengagement member 904 are oriented vertically, but a different orientation may be utilized in other embodiments. Further, two disengagement members 904 are utilized in the embodiment shown. However, one or more disengagement members 904 may be utilized in other embodiments or a single circular disengagement member may be used. The disengagement member 904 may take another form to separate the water filter 900 from the filter receiving portion 902, and the embodiment shown herein is merely an example. For example, the disengagement member 904 may be driven by a motor and one or more gears rather than a piston 912.

While an installation assistance feature is described as being used within an appliance in several embodiments, this feature may be provided for devices or systems other than appliances. For example, the installation assistance feature may be implemented on a direct water line within a home or some other setting, the installation assistance feature may be provided within manufacturing, chemical, or electrical plants for the filtration of water or some other fluids.

### Example System Architecture

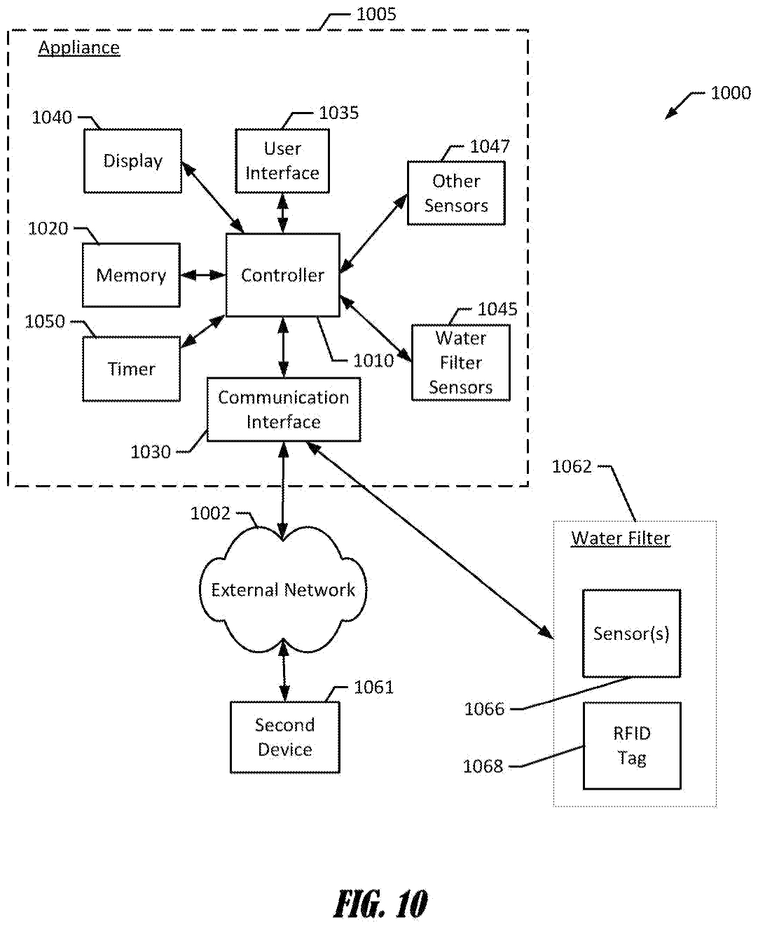

FIG. 10 shows a block diagram of an example system 1000 of various embodiments of the present invention described herein. The illustrated system 1000 includes an appliance 1005 and a water filter 1062, although other systems and devices may be included in various example systems described herein. In this regard, the system 1000 may include any number of different systems, modules, or components; each of which may comprise any device or means embodied in either hardware, software, or a combination of hardware and software configured to perform one or more corresponding functions described herein.

The appliance 1005 may include one or more controllers 1010, a memory 1020, a communication interface 1030, a user interface 1035, and a display 1040. The appliance 1005 may also comprise one or more water filter sensors 1045 and other sensors 1047. One or more of the components of the appliance 1005 may be located within a housing or could be separated into multiple different housings (e.g., be remotely located).

The controller(s) 1010 may be any means configured to execute various programmed operations or instructions stored in a memory device (e.g., memory 1020) such as a device or circuitry operating in accordance with software or otherwise embodied in hardware or a combination of hardware and software (e.g. controller(s) operating under software control or controller(s) embodied as an application specific integrated circuit (ASIC) or field programmable gate array (FPGA) specifically configured to perform the operations described herein, or a combination thereof) thereby configuring the device or circuitry to perform the corresponding functions of the controller(s) 1010 as described herein. In this regard, the controller(s) 1010 may be configured to analyze electrical signals communicated thereto to provide or receive data to or from connected components. For example, the controller(s) 1010 may be configured to receive data from the one or more water filter sensors 1045 and cause the display 1040 to indicate that the water filter 1062 is in an installed position based on the data received from the one or more water filter sensors 1045.

In an example embodiment, the memory 1020 may include one or more non-transitory storage or memory devices such as, for example, volatile and/or non-volatile memory that may be either fixed or removable. The memory 1020 may be configured to store instructions, computer program code, a count related to the time that a water filter 1062 has been in an installed position, location/position data, and other data associated with the system in a non-transitory computer readable medium for use, such as by the controller(s) for enabling the appliance 1005 to carry out various functions in accordance with example embodiments of the present invention. For example, the memory 1020 could be configured to buffer input data for processing by the controller(s) 1010. Additionally or alternatively, the memory 1020 could be configured to store instructions for execution by the controller(s) 1010.

The communication interface 1030 may be configured to enable connection to external systems (e.g. an external network 1002). In this manner, the appliance 1005 may retrieve stored data from a second device 1061 via the external network 1002 in addition to or as an alternative to the onboard memory 1020. Additionally or alternatively, the appliance 1005 may transmit or receive data such as sensor data or the like to or from a water filter 1062.

The appliance 1005 may also include one or more communications modules within the communication interface 1030 configured to communicate with one another in any of a number of different manners including, for example, via the external network 1002. In this regard, the communications interface 1030 may include any of a number of different communication backbones or frameworks including, for example, Ethernet, GPS, cellular, WiFi, or other suitable networks. The network may also support other data sources, including GPS, proximity sensors, etc. In this regard, numerous other peripheral devices (including other appliances or devices) may be included in the system 1000.

The one or more water filter sensors 1045 may be configured to determine the current position (e.g., the first position or the installed position) and/or orientation of the water filter 1062 relative to the appliance 1005 and/or the filter receiving portion. Various example sensors include infrared sensors, proximity sensors, float sensors, magnetic sensors, etc. Additionally or alternatively, the one or more water filter sensors 1045 may be configured to sense identification or other data from the water filter. For example, the one or more water filter sensors 1045 may take the form of a radio-frequency identification (“RFID”) sensor and may sense data of an RFID tag 1068 on the water filter 1062. However, other example such sensors may include an optical sensor, a camera, a contact sensor, other type of read/write sensors, etc. As described herein, the one or more water filter sensors 210 may be a single sensor or multiple sensors. Further, the multiple sensors may be different types of sensors and may be positioned and/or aimed differently depending on the desired circumstance being sensed. In some embodiments, functionality can be shared between sensors and/or multiple sensor data may be utilized to determine occurrence of a circumstance, such as described herein. While RFID sensors and RFID tags 1068 are contemplated, other alternatives may also be used. For example, ultra wide-band RTLS, Wi-Fi RTLS, and infrared RTLS approaches may be used. Alternatively, Bluetooth, Bluetooth Low Energy (“BLE”), or Wi-Fi may be used with accompanying beacons or transmitters. An RFID tag, a RTLS tag, a beacon or a transmitter may serve as a tracking unit, and a controller may be configured to receive information from the tracking unit through the applicable approach listed above. An integrated circuit (“IC”) may be used in some embodiments.

Additionally, a functionality control system may be provided in some embodiments. For example, various data could be utilized with the functionality control system, such as data about the water filter, a controller in an appliance or other system, the filter receiving portion, or the system generally. In some embodiments, the data (or portions thereof) may be gathered from the installed water filter (e.g., via an RFID tag or other feature). The controller may process this information to determine that the water filter is authorized or appropriate for use with the subject system. In some embodiments, the functionality control system may involve a controller detecting that the user is attempting to install an unauthorized water filter. Where this occurs, the controller may prevent or limit normal operation until an authorized water filter is used, the controller may cause an alert message to be provided on a display, the controller may override a filter in read/write control logic so that the filter appears to be in an uninstalled position, and/or the controller may cause another action to be taken. Example functionality that may be disabled or limited includes preventing water from flowing through the filter, not utilizing timer usage for determining when a new filter is needed, among other things. Example functionality that may be performed when an unauthorized filter is detected may include providing an alert regarding the unauthorized filter, initiating an ejection protocol for removing the unauthorized filter, among other things.

The display 1040, e.g. one or more screens, may be configured to present images and may include or otherwise be in communication with a user interface 1035 configured to receive input from a user. The display 1040 may be, for example, a conventional LCD (liquid crystal display), a touch screen display, mobile device, or any other suitable display known in the art upon which images may be displayed.

In some embodiments, the display 1040 may present one or more sets of data related to the installation of the water filter 1062 (or images generated from the one or more sets of data). This data may include an indication of whether the water filter 1062 is within the appliance 1005 and/or the filter receiving portion, the position of the water filter 1062, the orientation of the water filter 1062, whether the water filter 1062 is or is not in an installed position, the time remaining until the water filter 1062 will be positioned in or removed from the installed position, and the time remaining until a replacement water filter is needed. In some embodiments, the display 1040 may also present information about the type of water filter 1062 being used and provide an indication of whether the water filter 1062 is approved.

The user interface 1035 may include, for example, a keyboard, keypad, function keys, mouse, scrolling device, input/output ports, touch screen, or any other mechanism by which a user may interface with the system.

Although the display 1040 of FIG. 10 is shown as being directly connected to the controller(s) 1010 and within the appliance 1005, the display 1040 could alternatively be remote from the controller(s) 1010 and/or appliance 1005. Likewise, in some embodiments, the one or more water filter sensors 1045 and/or user interface 1035 could be remote from the appliance 1005.

The appliance 1005 may include one or more other sensors 1047 configured to measure or sense various other conditions. The other sensors 1047 may include, for example, sensors that detect whether the appliance 1005 is currently in operation, whether water is flowing through the fluid flow path 202 (FIG. 2) of the appliance 200, etc.

The water filter 1062 illustrated in FIG. 10 may comprise one or more sensors 1066 and an RFID tag 1068. In some embodiments, the water filter 1062 may also include its own controller (although not shown) configured to perform various functions, such as processing related to sensor data received from the one or more sensors 1066. In some embodiments, the controller(s) (e.g., controller(s) 1010 in the appliance 1005, a controller in the water filter 1062, or a controller in a second device 1061—or combinations thereof) may be configured to process sensor data and/or selectively control the installation or deinstallation of the water filter 1062. In some embodiments, the one or more sensors 1066 may complement the one or more water filter sensors 1045 so as to work in conjunction for various functions. In some embodiments the one or more sensors 1066 may comprise sensors that perform additional functionality (e.g., sense the amount of water flowing through the water filter, sense the degree of use of the filter(s) in the water filter, etc.).

### Example Flowchart(s) and Operations

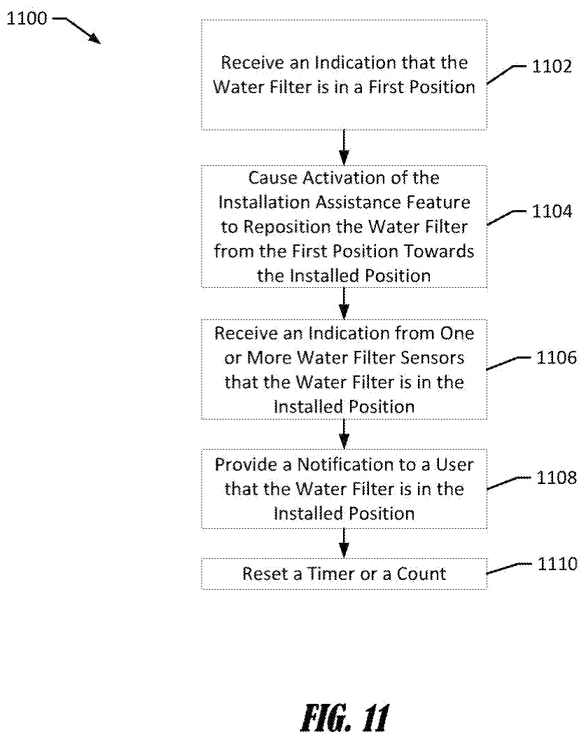

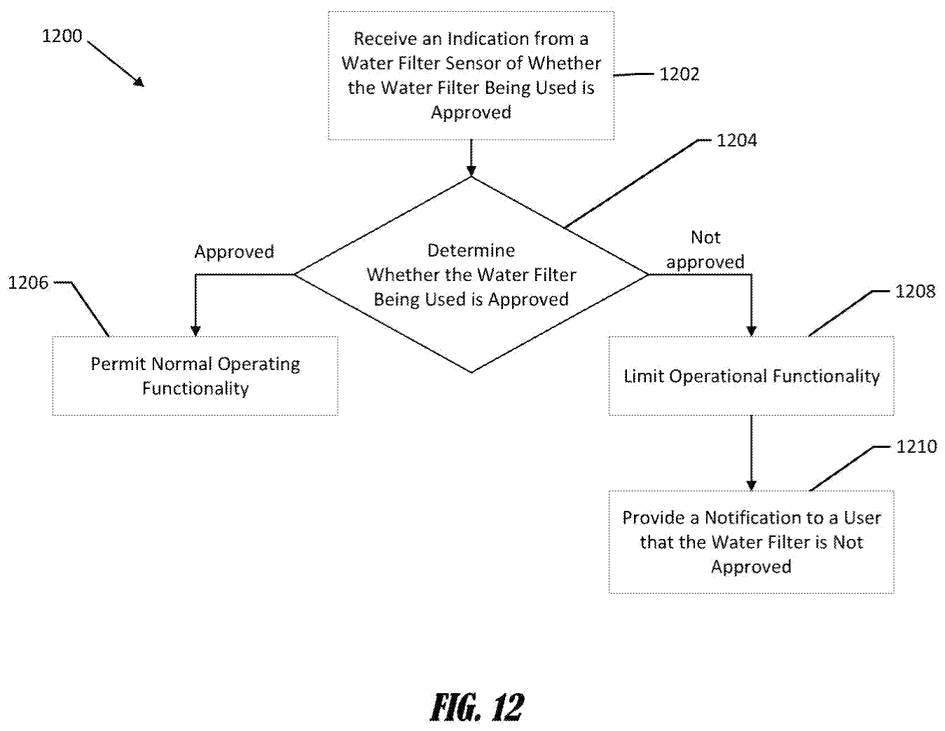

Embodiments of the present invention provide methods, apparatus and computer program products for installing a water filter 700 (FIGS. 7A-7B) within a filter receiving portion 701 and/or an appliance. Various examples of the operations performed in accordance with embodiments of the present invention will now be provided with reference to FIGS. 11-12.

FIG. 11 illustrates a flowchart 1100 according to an example method for installing a water filter 700 (FIGS. 7A-7B) and instructions that may be executed by at least one controller to install a water filter 700 according to example embodiments. For example, the at least on controller 1010 (FIG. 10) may execute the instructions to assist with installing the water filter. While the operations illustrated in and described with respect to FIG. 11 are performed by at least one controller, the operations may also, for example, be performed by, with the assistance of, and/or under the control of one or more of a processor, a memory 1020 (FIG. 10), display 1040 (FIG. 10), a water filter sensor 1045, an external network 1002, and/or a second device 1061. At operation 1102, an indication is received that the water filter 1062 (FIG. 10) is in a first position. The water filter 1062 may be detected, for example, by the one or more water filter sensors 1045. However the water filter 1062 may be detected in other ways as well. Upon the water filter 1062 being detected, the relevant sensor or component that detected the water filter 1062 may provide an indication to the at least one controller 1010.

At operation 1104, the at least one controller causes the installation assistance feature 450 (FIG. 4D) to be activated based on the indication that the water filter 1062 (FIG. 10) is in a first position. Activation causes the water filter 1062 to be repositioned from the first position towards the installed position. This activation may result in the activation of a motor 420. As shown in FIG. 4D, activation of the motor 420 causes rotation of the first member 411 and the associated inclined track 413, and activation of the motor 420 also causes the water filter 1062 (FIG. 10) to shift towards the installed position.

At operation 1106, the at least one controller receives an indication from one or more water filter sensors 1045, 1066 that the water filter 1062 is in the installed position.

At operation 1108, the at least one controller provides a notification to a user that the water filter 1062 (FIG. 10) is in the installed position. This notification may be presented on the display 103 (FIG. 1), the notification may be made by causing a light 108 on the appliance 100 to be turned on or to change in color, or the notification may be made by generating a sound in the appliance 100 that is communicated by the speaker 110. The notification may also be provided by causing a vibration of the appliance 100 or by sending a notification to another device or a second device 1061 (FIG. 10) to notify the user. A notification may be provided in other manners as well.

At operation 1110, the at least one controller, based on the indication that the water filter 1062 (FIG. 10) is in the installed position, will reset at least one of a timer 1050 or a count corresponding to an estimated time (e.g., date) of replacement for the water filter 1062. By resetting this timer 1050, the user may be notified when the water filter 1062 needs to be replaced. A count may be stored within the memory 1020 (FIG. 10) of the appliance 1005 or within memory at another location.

While FIG. 11 presents the operations executed by at least one controller in a specified order, the order of operations may be altered and/or some operations may be added or omitted in other embodiments. For example, in some embodiments, only operations 1102 and 1104 are performed, and in other embodiments, only one of operations 1108 and 1110 are performed.

FIG. 12 illustrates a flowchart according to an example method 1200 for operating a water filter sensor 1045 (FIG. 10) and instructions that may be executed by at least one controller 1010 to operate a water filter sensor 1045. While the operations illustrated in and described with respect to FIG. 12 are performed by at least one controller, the operations may also, for example, be performed by, with the assistance of, and/or under the control of one or more of a processor, memory 1020 (FIG. 10), display 1040, a water filter sensor 1045, an external network 1002, and/or a second device 1061.

At operation 1202, the at least one controller 1010 (FIG. 10) receives an indication from a water filter sensor 1045 of whether the water filter 1062 being used is approved. This may be accomplished by using an RFID sensor to receive information about a water filter 1062 via an RFID tag 1068 within the water filter 1062. In some embodiments, a controller within a second device 1061 may determine whether the water filter 1062 is approved, and the second device 1061 may provide an indication to the communication interface 1030 of whether the water filter 1062 being used is approved. However, information about the water filter 1062 being used may be received in other ways (e.g. a hard-wire connection between the water filter 1062 and the communication interface 1030, communication via the external network 1002, etc.).

Then, at operation 1204, a determination is made as to whether or not the water filter 1062 (FIG. 10) being used is approved based on the provided indication. This determination may be made by interpreting the information received from the water filter 1062 or from another device 1061 about the water filter 1062. If the water filter 1062 (FIG. 10) being used is approved, then the at least one controller proceeds to execute operation 1206. If the water filter 1062 (FIG. 10) being used is not approved, then the at least one controller 1010 proceeds to execute operation 1208 and/or operation 1210.

At operation 1206, the at least one controller 1010 (FIG. 10) permits normal operational functionality, such as allowing the flow of fluid along the fluid flow path. At operation 1208, the at least one controller 1010 (FIG. 10) limits operational functionality, such as by limiting the flow of fluid along the fluid flow path. For example, the flow of fluid may be limited by leaving the valve assembly 800 (FIG. 8A) or the valve assembly shown in FIGS. 7A and 7B in a closed state. This may be accomplished by preventing the water filter 700 (FIG. 7A) from pushing the valve assembly and causing the valve assembly from shifting to an open state, but this may also be accomplished by including a lock mechanism to prevent the valve assembly from opening. Additionally, the flow of fluid may be limited by including a second valve assembly which may be controlled by mechanical inputs, electrical signals from the at least one controller 1010 (FIG. 10), etc. Additionally or alternatively, for example, the at least one controller may adversely affect operation of the appliance by, for example, limiting the modes of operation for the appliance.

Additionally or alternatively to operation 1208, operation 1210 may be performed. At operation 1210, the at least one controller 1010 (FIG. 10) provides a notification to the user that the water filter 1062 is not approved. This notification may be presented on the display 103 (FIG. 1), the notification may be made by causing a light 108 on the appliance 100 to be turned on or to change in color, or the notification may be made by generating a sound in the appliance 100 that is communicated by the speaker 110. The notification may also be provided by causing a vibration of the appliance 100 or by sending a notification to another device or a second device 1061 (FIG. 10) to notify the user. A notification may be provided in other manners as well.

While FIG. 12 presents the operations executed by at least on controller in a specified order, the order of operations may be altered and/or some operations may be added or omitted in other embodiments. For example, in some embodiments, only one of operations 1208 and 1210 is performed, and in other embodiments, operation 1210 may be performed prior to operation 1208.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. An appliance, the appliance comprising:
a fluid flow path;
a filter receiving portion configured to receive a water filter and fluidly connect the water filter to the fluid flow path, wherein the filter receiving portion comprises an installation assistance feature, wherein, when the water filter is in an installed position, the water filter is fluidly connected to the fluid flow path; and
at least one controller configured to:
receive an indication that the water filter is in a first position, wherein the first position is relative to the filter receiving portion so as to enable initiation of an installation procedure to cause the water filter to move to the installed position, wherein the installation procedure utilizes the installation assistance feature; and
cause, based on the indication that the water filter is in the first position, activation of the installation assistance feature to reposition the water filter from the first position towards the installed position.

2. The appliance of claim 1 further comprising one or more water filter sensors configured to sense when the water filter is in a first position, and wherein the indication that the water filter is in the first position is based on sensor data from the one or more water filter sensors.

3. The appliance of claim 1 further comprising one or more water filter sensors, and wherein the at least one controller is further configured to receive an indication from the one or more water filter sensors that the water filter is in the installed position.

4. The appliance of claim 3, wherein the at least one controller is further configured to provide, based on the indication that the water filter is in the installed position, a notification to a user that the water filter is in the installed position.

5. The appliance of claim 3, wherein the at least one controller is further configured to reset, based on the indication that the water filter is in the installed position, at least one of a timer or a count corresponding to an estimated time of replacement for the water filter.

6. The appliance of claim 1, wherein the appliance is one of a refrigerator, a freezer, a dishwasher, a washing machine, a dryer, a water cooler, a water dispenser, an ice maker, a water heater, or a water purifier.

7. The appliance of claim 1, wherein the installation assistance feature is configured to move the water filter in a first direction without the water filter rotating relative to the appliance.

8. The appliance of claim 7, wherein the installation assistance feature further comprises a first member, wherein the first member is configured to rotate about a first axis, wherein the first member comprises an inclined track, wherein the inclined track is configured to receive the water filter, wherein, upon rotation of the first member and the inclined track, the water filter moves along the first axis without rotating relative to the appliance.

9. The appliance of claim 8, wherein the installation assistance feature further comprises a motor and a drive gear, wherein the motor is configured to operate to cause the drive gear to rotate to cause the rotation of the first member.

10. The appliance of claim 7, wherein one of the water filter or the appliance defines a recess configured to receive a corresponding key extending from the other of the water filter or the appliance, wherein, when the key is received within the recess, the recess is configured to prevent rotation of the water filter relative to the appliance while the water filter moves to the installed position.

11. The appliance of claim 1 further comprising one or more water filter sensors, and wherein the at least one controller is configured to determine, based on sensor data from the one or more water filter sensors, if the water filter being used is approved, and wherein the at least one controller is configured to adversely affect operation of the appliance if the water filter is not approved.

12. The appliance of claim 11, further comprising a valve, wherein the valve is configured to limit flow of fluid along the fluid flow path if the water filter is not approved.

13. The appliance of claim 1, wherein the filter receiving portion comprises a magnetic material, wherein the magnetic material of the filter receiving portion is configured to form a magnetic bond with the water filter when the water filter is in the first position.

14. The appliance of claim 13, wherein the filter receiving portion comprises a disengagement member, wherein the disengagement member is configured to apply a force to displace the water filter from the installed position.

15. The appliance of claim 13, wherein the filter receiving portion comprises an electromagnet containing the magnetic material, wherein the electromagnet is configured to generate a magnetic field when electrical current is provided to the electromagnet, wherein the electromagnet is configured to generate no magnetic field when electrical current is not provided to the electromagnet, wherein the at least one controller is configured to control provision of electrical current to the electromagnet.

16. The appliance of claim 1 further comprising one or more water filter sensors, and wherein the at least one controller is configured to provide, after receiving an indication from one or more water filter sensors that the water filter is in an installed position, an indication to a user that the water filter is in the installed position by performing at least one of the following actions:
sending a signal to a display on the appliance;
sending a notification to another device;
causing a light on the appliance to be turned on or change color;
causing a sound to be generated by the appliance; or
causing vibration of the appliance.

17. A filter receiving portion for receiving a water filter, the filter receiving portion comprising:
an installation assistance feature, wherein, when the water filter is in an installed position, the water filter is fluidly connected to a fluid flow path; and
at least one controller configured to:
receive an indication that the water filter is in a first position, wherein the first position is relative to the filter receiving portion so as to enable initiation of an installation procedure to cause the water filter to move to the installed position, wherein the installation procedure utilizes the installation assistance feature; and
cause, based on the indication that the water filter is in the first position, activation of the installation assistance feature to reposition the water filter from the first position towards the installed position.

18. The filter receiving portion of claim 17, wherein the at least one controller is further configured to receive an indication from the one or more water filter sensors that the water filter is in the installed position.

19.-25. (canceled)

26. A water filter comprising:
a water inlet;
a water outlet;
a filter fluid path extending from the water inlet to the water outlet;
one or more filter elements in the filter fluid path; and
one or more engagement elements,
wherein the water filter is configured to be received within a filter receiving portion at a first position, wherein the one or more engagement elements are configured to receive a force from the filter receiving portion so as to cause the water filter to move to an installed position in an appliance, wherein, when the water filter is in the installed position, the water filter is fluidly connected to a fluid flow path of the appliance.

27.-29. (canceled)

30. The water filter of claim 26, further comprising a tracking unit, wherein the tracking unit is selected from the group consisting of an RFID tag, an RTLS tag, a beacon, or a transmitter, wherein a controller may be configured to receive information from the tracking unit through at least one of RFID, ultra wide-band RTLS, Wi-Fi RTLS, infrared RTLS, Bluetooth, Bluetooth Low Energy (“BLE”), or Wi-Fi.
